(19) United States
(12) Patent Application Publication
(10) Pub. No.: US 2007/0252822 A1
(43) Pub. Date: Nov. 1, 2007

(54) Apparatus, method, and medium for providing area division unit having touch function

(75) Inventors: Hyun-jin Kim, Yongin-si (KR); Dong-kyung Nam, Yongin-si (KR); Hyun-jeong Lee, Yongin-si (KR); Jin-kwang Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/649,160

(22) Filed: Jan. 4, 2007

(30) Foreign Application Priority Data
May 1, 2006 (KR) 10-2006-0039298

(51) Int. Cl. G06F 3/041

(52) U.S. Cl. 345/173

(57) ABSTRACT

Provided are an apparatus, method, and medium for providing an area division unit having a touch pad function, and more particularly, an apparatus and method for providing an area division unit having a touch pad function which are capable of dividing a display screen of a display device into one or more display areas using an area division unit equipped with a transparent touch pad and allowing a user to choose and execute one of a plurality of menu items that are displayed on the display screen and are seen through the transparent touch pad. The apparatus includes an area division unit which can be moved in a predetermined direction by a user and can thus divide a display screen into one or more display areas, the display screen which is divided into one or more display areas according to the location of the area division unit, and a touch pad which is attached on the top surface of the area division unit and allows the user to choose and execute one of a plurality of icons displayed on the display screen.

### CROSS-REFERENCE TO RELATED APPLICATIONS

This application claims priority from Korean Patent Application No. 10-2006-0039298 filed on May 1, 2006 in the Korean Intellectual Property Office, the disclosure of which is incorporated herein by reference in its entirety.

### BACKGROUND OF THE INVENTION

1. Field of the Invention

The present invention relates to an apparatus, method, and medium for providing an area division unit having a touch pad function, and more particularly, to an apparatus, method, and medium for providing an area division unit having a touch pad function, the apparatus, method, and medium capable of dividing a display screen of a display device using an area division unit equipped with a transparent touch pad and allowing a user to choose and execute one of a plurality of menu items that are displayed on the display screen and are seen through the transparent touch pad.

2. Description of the Related Art

Recently, a variety of content providing servers capable of providing data streams of various moving image programs via a network such as the Internet or a mobile network have been commercialized.

Accordingly, personal computers connected to the Internet, mobile phones connected to a mobile communication network, personal data assistants (PDAs) connected to an access point, or portable media players (PMPs) can receive in real time various data streams transmitted by such content providing servers, process the received data streams, and enable users to watch various moving image programs via a network.

In particular, PMPs are portable devices capable of playing back various multimedia files (e.g., video, music, and photo files) ranging from MP3 music files to still image/moving image content items. PMPs have a variety of additional functions and are designed as embedded systems comprised of a CPU, a memory, an auxiliary memory device, and other peripheral devices so as to perform multiple tasks.

In order to perform multiple tasks using a PMP, it is necessary to perform menu manipulation using external buttons. However, mismatches between menu buttons displayed on a PMP screen and such external buttons result in poor intuitive operability.

Conventionally, when performing multiple tasks using a PMP, a display screen is divided into one or more display areas of a predefined size so that the areas can respectively display a plurality of content items. However, it is impossible to divide a display screen into one or more display areas of a size desired by a user.

In the meantime, Korean Patent Laid-Open Gazette No. 2004-071767, entitled “Touch-Screen Image Scrolling System and Method,” discloses a touch-screen responsive system which displays a scrolling motion as an image on a display screen in response to the movement of a user's finger that contacts the display screen. This system, however, cannot provide a clear screen image especially when an entire display screen is used as a touch screen. Also, this system lacks a function of dividing a single display screen into a plurality of areas of a predefined size and playing back a plurality of content items using the areas.

### SUMMARY OF THE INVENTION

Additional aspects, features, and/or advantages of the invention will be set forth in part in the description which follows and, in part, will be apparent from the description, or may be learned by practice of the invention.

The present invention provides an apparatus, method, and medium for controlling the division of a display screen of a display device according to a user's preferences by moving an area division unit according to arbitrary user manipulation and dividing the display screen into one or more display areas according to the location of the area division unit.

The present invention also provides an apparatus, method, and medium for enabling a user to intuitively choose one of a plurality of icons that are displayed on a display screen and are seen through a transparent touch pad by installing the transparent touch pad on the top surface of an area division unit.

According to an aspect of the present invention, there is provided an apparatus for providing an area division unit having a touch pad function. The apparatus includes an area division unit which can be moved in a predetermined direction by a user and can thus divide a display screen into one or more display areas, the display screen which is divided into one or more display areas according to the location of the area division unit, and a touch pad which is attached on the top surface of the area division unit and allows the user to choose and execute one of a plurality of icons displayed on the display screen.

According to another aspect of the present invention, there is provided an apparatus for providing an area division unit having a touch pad function. The apparatus includes a first signal input module which receives a signal that is generated when an area division unit is moved, a second signal input module which receives a touch signal that is generated when a user touches a touch pad, an area division unit location determination module which determines the location of the area division unit relative to a display screen based on the signal received by the first signal input module, a touch location calculation module which calculates a touch location on the display screen that is chosen by the user, based on the touch signal received by the second signal input module and the location of the area division unit determined by the area division unit location determination module, and a control module which divides the display screen according to the location of the area division unit determined by the area division unit location determination module.

According to another aspect of the present invention, there is provided a method of providing an area division unit having a touch pad function. The method includes receiving a signal that is generated when a user moves an area division unit, determining the location of the area division unit relative to a display screen based on the received signal, dividing the display screen according to the determined location of the area division unit, receiving a touch signal that is generated when the user touches a touch pad, calculating a touch location on the display screen that is chosen by the user, based on the received touch signal and the determined location of the area division unit, and activating an icon corresponding to the calculated touch location.

According to another aspect of the present invention, there is provided a display apparatus, including: a movable area divider to divide a display screen into two or more display areas, wherein size of at least one display area is determined by location of movable area divider; and a touch pad which is attached on a top surface of the movable area divider and which is touched by a user to select one of a plurality of icons displayed on one of the display areas.

According to another aspect of the present invention, there is provided a display apparatus having a movable area divider, the display apparatus including: a first signal input module which receives a signal that is generated when the movable area divider is moved; a second signal input module which receives a touch signal that is generated when a user touches a touch pad attached to the movable area divider; an area divider location determination module which determines the location of the movable area divider relative to a display screen based on the signal received by the first signal input module; a touch location calculation module which calculates a touch location on the display screen that is selected by the user, based on the touch signal received by the second signal input module and the location of the movable area divider determined by the area divider location determination module; and a control module which divides the display screen according to the location of the movable area divider determined by the area divider location determination module.

According to another aspect of the present invention, there is provided a method for dividing a display screen into display areas and adjusting size of content displayed in display areas, including: receiving a signal that is generated when a user moves a movable area divider; determining location of the movable area divider relative to the display screen based on the received signal; dividing the display screen according to the determined location of the movable area divider into the display areas; receiving a touch signal that is generated when the user touches a touch pad attached to the movable area divider; calculating a touch location on the display screen that is selected by the user, based on the received touch signal and the determined location of the movable area divider; activating an icon corresponding to the calculated touch location; and adjusting the size of content displayed in at least one of the display areas into which the display screen is divided by the movable area divider according to the size of the at least one display area.

According to another aspect of the present invention, there is provided a movable area divider attached to a touch pad, wherein the movable area divider divides a display screen into at least three display areas which display an icon, content item corresponding to the icon, and information corresponding to the icon in three separate display areas; and size of content item displayed in one of the at least three separate display areas is adjusted according to location of the movable area divider which defines size of each display area.

According to another aspect of the present invention, there is provided a movable area divider attached to a touch pad, wherein: the movable area divider divides a display screen into at least two separate display areas which display an icon and content item corresponding to the icon in two separate display areas; and size of content item displayed in at least one of the display areas is adjusted according to location of the movable area divider which defines size of each display area.

According to another aspect of the present invention, there is provided at least one computer readable medium storing computer readable instructions that control at least one processor to implement the methods of the present invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a schematic view of an apparatus for providing an area division unit having a touch pad function according to an exemplary embodiment of the present invention;

FIGS. 2A and 2B are cross-sectional views of an apparatus for providing an area division unit having a touch pad function according to another exemplary embodiment of the present invention;

FIG. 3 is a cross-sectional view of an apparatus for providing an area division unit having a touch pad function according to another exemplary embodiment of the present invention and explains the determining of the location of the area division unit and the calculation of a touch location by the apparatus;

FIG. 4 is a block diagram of an apparatus for providing an area division unit having a touch pad function according to another exemplary embodiment of the present invention;

FIG. 5 is a schematic view of an apparatus for providing an area division unit having a touch pad function according to another exemplary embodiment of the present invention and explains the calculation of a touch location by the apparatus;

FIG. 6 is a flowchart illustrating a method of providing an area division unit having a touch pad function according to an exemplary embodiment of the present invention;

FIGS. 7A, 7B, and 7C are diagrams for explaining the moving of an area division unit according to an exemplary embodiment of the present invention;

FIGS. 8A and 8B are diagrams for explaining the choosing of an image of interest displayed in a second display area using an area division unit according to an exemplary embodiment of the present invention; and

FIG. 9 is a diagram for explaining the performing of a multi-tasking function using first and second display areas according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

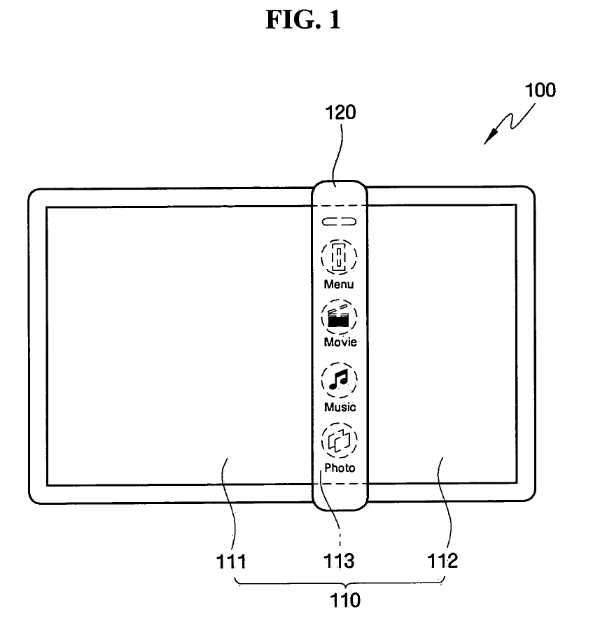

FIG. 1 is a schematic view of an apparatus 100 for providing an area division unit having a touch pad function according to an exemplary embodiment of the present invention. Referring to FIG. 1, the apparatus 100 includes a display screen 110 and an area division unit (area divider) 120. The apparatus 100 is a display apparatus that provides images, audio data, and video data. Examples of the apparatus 100 include personal digital assistants (PDAs), portable multimedia players (PMPs), digital cameras, portable game players, and mobile phones. An example of a PMP is a MP3 player. Further, it is understood that the present invention is also applicable to any apparatus with which an apparatus 100 of an exemplary embodiment of the present invention can be used.

The display screen 110 is divided into a first display area 111, a second display area 112, and a third display area 113. The first display area 111 is a main screen, and displays and/or outputs a content item (e.g., an image, video data, and audio data) corresponding to an icon chosen (selected) by a user.

The second display area 112 is an auxiliary screen, and displays information corresponding to the icon chosen by the user. The display screen 110 is divided into the first and second display areas 111 and 112 by the area division unit 120.

For example, when the icon chosen by the user is a movie play icon and the user chooses one of a plurality of movie files included in the movie play icon, the movie file chosen by the user is played back in the first display area 111, and a plurality of images respectively corresponding to the movie files are displayed in the second display area 112 as thumbnail images. Here, the second display area 112 may display not only information included in the icon chosen by the user but also major scenes captured from the movie file played back in the first display area 111 as thumbnail images.

The third display area 113 is an area of the display screen 110 where the area division unit 120 is located. The third display area 113 may display a plurality of menu icons/operation control icons such as an MP3 play icon, a pause icon, a fast forward icon, and a rewind icon.

The area division unit 120 divides the display screen 110 by being laterally moved by the user. The display screen 110 is divided into the first and second display areas 111 and 112 by the area division unit 120. Accordingly, the size of content to be displayed in each of the first and second display areas 111 and 112 is automatically varied according to the size of the corresponding display area.

The third display area 113 is provided on a portion of the display screen 110 where the area division unit 120 is located. Accordingly, the location of the third display area 113 is varied according to the location of the area division unit 120.

A touch pad (not shown) which is formed of a transparent material is attached on the surface of the area division unit 120. Accordingly, the menu icons/operation control icons displayed in the third display area 113 can be seen through the area division unit 120. Accordingly, the menu icons/operation control icons displayed in the third display area 113 are seen through the area division unit 120 so that the user can choose and execute any of the menu icons/operation control icons displayed in the third display area 113. The touch pad may be formed of a transparent and rigid material such as acrylic.

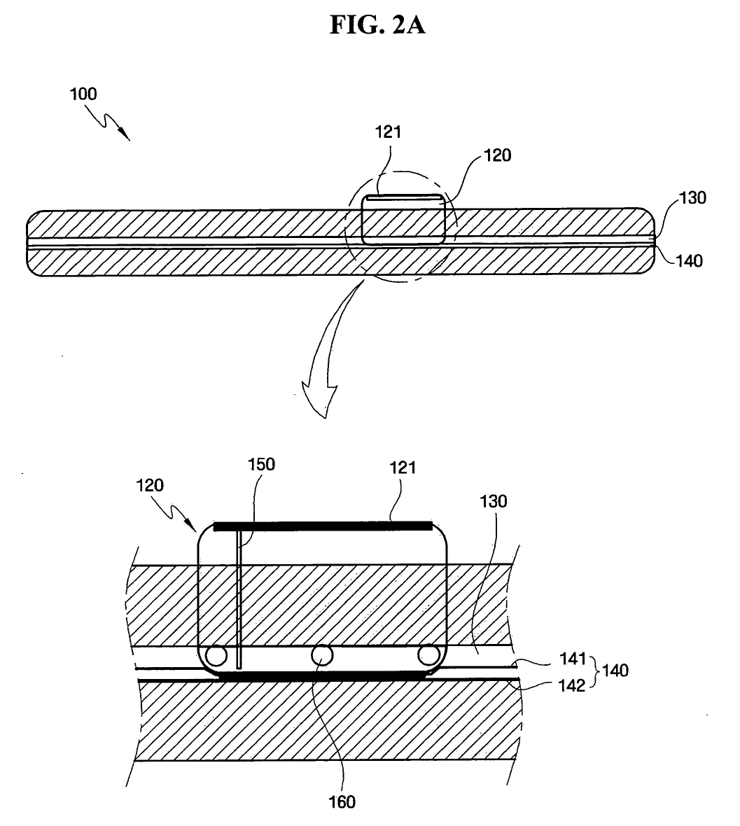

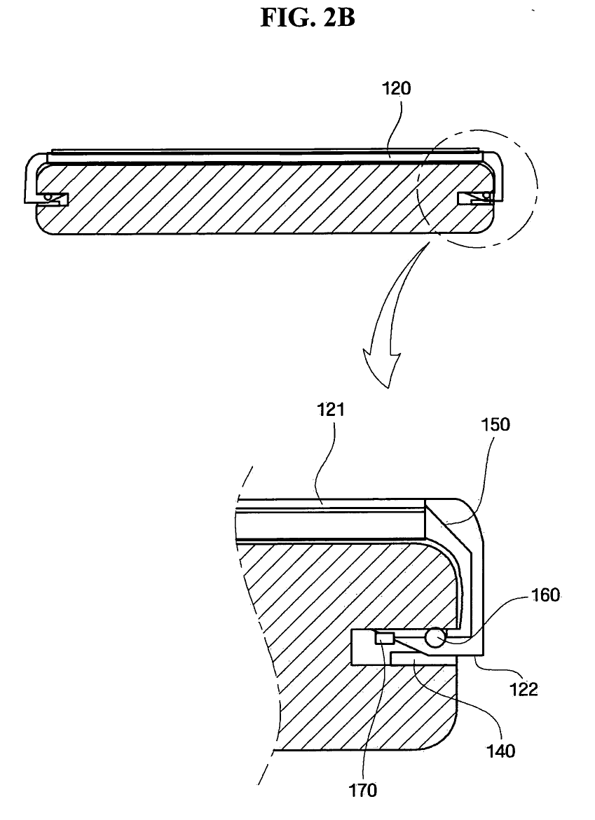

The user can move his/her finger vertically or horizontally on the touch pad in order to choose a content item or an image displayed in the second display area 112. The structure of the apparatus 100 will hereinafter be described in further detail with reference to FIG. 2.

FIGS. 2A and 2B are cross-sectional views of an apparatus 100 for providing an area division unit having a touch pad function according to another exemplary embodiment of the present invention the apparatus illustrated in FIG. 1. Specifically, FIG. 2A is a horizontal cross-sectional view of a display apparatus 100. Referring to FIG. 2A, an area division unit groove 130 is formed in the display apparatus 100. A connection portion (not shown) of an area division unit 120 fits in the area division unit groove 130 so that the area division unit 120 is coupled to the display apparatus 100.

The area division unit groove 130 can be moved, for example, laterally, when the area division unit 120 is moved laterally by a user. The area division unit groove may be formed of a rigid material such as aluminum, magnesium, or acrylic.

The connection portion of the area division unit 120 includes such an element as a bearing 160 that facilitates the movement of the area division unit 120. Thus, the area division unit 120 can be smoothly moved.

The selection of an icon by the user can be sensed by a transparent touch pad 121 which is attached on the top surface of the area division unit 120. For example, a touch signal is generated when the user chooses a touch pad 121 attached on the top surface of the area division unit 120. The touch signal is received via a first signal connection line 150. Then, the touch signal is transmitted to the display apparatus 100 via a second signal connection line (not shown).

A touch strip 140 is disposed in the area division unit groove 130. The touch strip 140 is comprised of two resistance lines 141 and 142 that are spaced apart by a spacer (not shown). In other words, when the area division unit 120 presses the touch strip 140, a voltage is applied to each of the resistance lines 141 and 142, and then, a contact is generated on the touch strip 140. Then, the location of the contact is detected. The touch strip 140 may be a resistive touch sensor that is linear or another touch sensor.

FIG. 2B is a vertical cross-sectional view of the display apparatus 100 illustrated in FIG. 2A. Referring to FIG. 2A, a touch signal that is generated when the touch pad 121 attached on the top surface of the area division unit 120 is received via the first signal connection line 150. Then, the touch signal is transmitted to the display apparatus 100 via the second signal connection line (not shown).

The first signal connection line 150 is attached and fixed to the inside of a connection portion 122 of the area division unit 120, and the second signal connection line is connected to the display apparatus 100 via a connector 170 of the connection portion 122. The length of the second signal connection line is determined in consideration of the mobility of the area division unit 120.

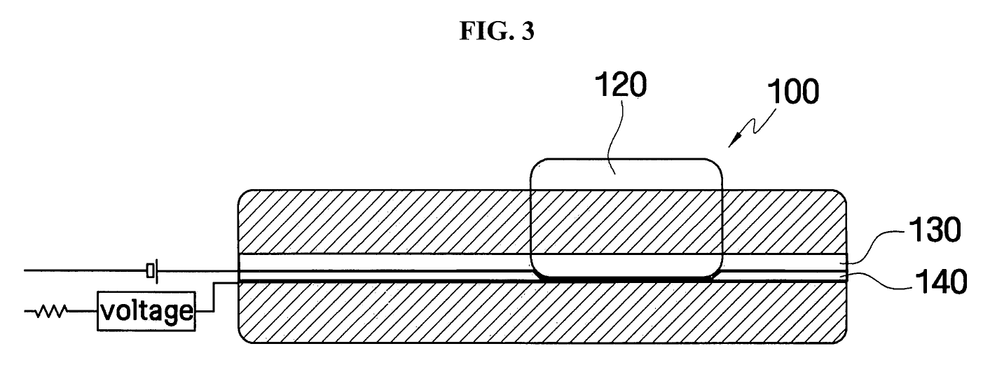

FIG. 3 is a cross-sectional view of an apparatus 100 for providing an area division unit according to another exemplary embodiment of the present invention the apparatus 100 illustrated in FIG. 1 and explains the determining of the location of the area division unit 120 and the calculation of a touch location by the apparatus 100.

The determining of the location of the area division unit 120 will hereinafter be described in detail with reference to FIG. 3.

Referring to FIG. 3, when a connection portion 122 of the area division unit 120 presses a touch strip 140, a contact is generated between an upper resistance line 141 and a lower resistance line 142, thus varying the resistance of the touch strip 140.

Thereafter, a variation in the voltage or current of the touch strip 140 is detected, and the result of the detection is converted into a digital signal by an analog-to-digital converter (ADC). A processor in the display apparatus 100 determines the location of the area division unit 120 relative to the display screen 110 using the digital signal provided by the ADC. The location of the area division unit 120 can be determined using a resistive touch sensor or another touch sensor.

The calculation of a touch location based on a touch signal generated when a user chooses the touch pad 121 will hereinafter be described in detail with reference to FIG. 3. Referring to FIG. 3, the touch pad 121 may be a four-wire or five-wire resistive touch panel. Alternatively, the touch pad 121 may be a touch sensor other than those set forth herein. For example, the touch pad 121 may be a touch sensor using a static capacitive method, an optical detection method, an optical waveguide method, an ultrasound method, a pressure detection method, or a metallic wire reclamation method.

When the user chooses the touch pad 121, a touch signal is generated. The touch signal is transmitted to the connector 170 via a first signal connection line (not shown).

Then, the touch signal is transmitted to a processor of the display apparatus 100 via a second signal connection line. Thereafter, the processor of the display apparatus 100 calculates the location of the touch pad 121 using the touch signal. A signal for determining the location of the area division unit 120 or the touch signal may be transmitted to the processor of the display apparatus 100 using an interrupt method or a scan method. Thereafter, the processor of the display apparatus 100 searches for an icon corresponding to the location of the touch pad 121, and executes a function of the identified icon.

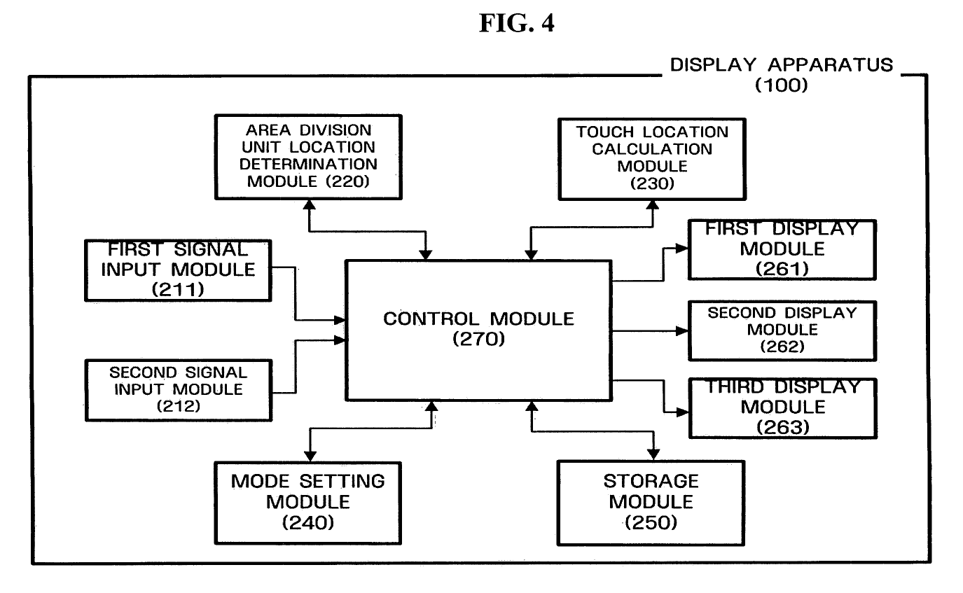

FIG. 4 is a block diagram of an apparatus 100 illustrated in FIG. 1 for providing an area division unit according to another embodiment of the present invention. Referring to FIG. 4, the apparatus 100 includes a first signal input module 211, a second signal input module 212, an area division unit location determination module 220, a touch location calculation module 230, a mode setting module 240, a storage module 250, a first display module 261, a second display module 262, a third display module 263, and a control module 270. The apparatus 100, which provides a movable touch pad, may be a display apparatus that provides images, and audio and video data, for example, a PDA, a PMP, digital camera, portable game player, or a mobile phone. An example of a PMP is a MP3 player. Further, it is understood that the present invention is also applicable to any apparatus with which an apparatus 100 of an exemplary embodiment of the present invention can be used. Thus, the apparatus 100 will hereinafter be referred to as the display apparatus 100.

Referring to FIG. 4, the first signal input module 211 receives a signal generated when the area division unit 120 is moved.

In detail, when a user moves an area division unit 120, the area division unit 120 presses a touch strip 140. Then, the resistance of the touch strip 140 varies. Accordingly, a voltage value corresponding to the variation in the resistance of the touch strip 140 is detected, and the result of the detection is converted into a digital signal by an ADC. The digital signal is input to the first signal input module 211.

The second signal input module 212 receives a touch signal generated when the user touches a touch pad 121.

In detail, when the user chooses an icon by touching the touch pad 121, a touch signal is generated. The touch signal is transmitted to a connector 170 via a first signal connection line. Then, the touch signal is transmitted to the second signal input module 212 via a second signal connection line.

The area division unit location determination module (area divider location determination module) 220 determines the location of the area division unit 120 relative to a display screen using the signal received by the first signal input module 211.

The touch strip 140 is comprised of two resistance lines 141 and 142 that are spaced apart by a spacer. When the area division unit 120 presses the touch strip 140, a voltage is applied to each of the resistance lines 141 and 142.

Then, a contact is generated on the touch strip 140. Accordingly, the resistance of the touch strip 140 varies, and the location of the area division unit 120 relative to the display screen can be determined based on a voltage value corresponding to the variation in the resistance of the touch strip 140.

The touch location calculation module 230 calculates a touch location chosen by the user based on the touch signal received by the second signal input module 212 and the location of the area division unit 120, which is determined by the area division unit location determination module 220.

In detail, when the user chooses one of a plurality of icons seen through the area division unit 120 with the aid of the touch pad 121, a touch signal corresponding to the chosen icon is input to the second signal input module 212 via the first and second signal connection lines.

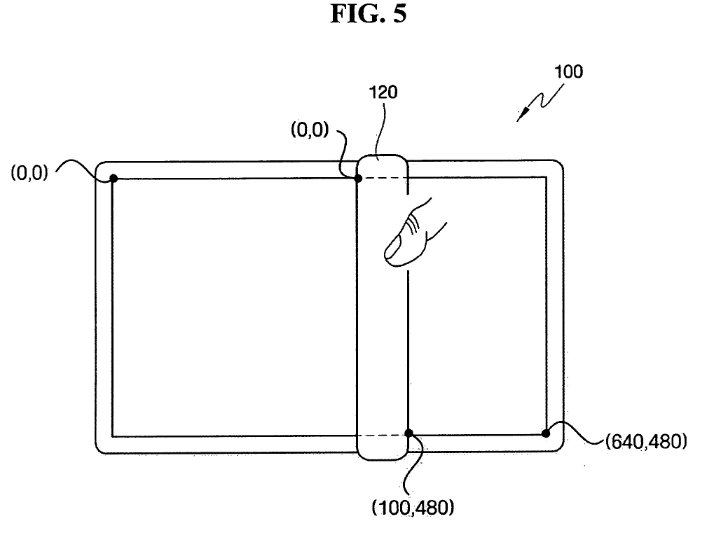

Then, the touch location calculation module 230 calculates a touch location chosen by the user based on the touch signal input to the second signal input module 212 and the location of the area division unit 120, which is determined by the area division unit location determination module 220. Thereafter, the control module 270 searches for an icon corresponding to the result of the calculation performed by the touch location calculation module 230, and executes a function of the identified icon. The calculation of a location chosen by the user with the aid of the touch pad 121 will hereinafter be described in further detail with reference to FIG. 5.

Referring to FIG. 5, assume the size of a display screen of the display apparatus 100 is 640×480, and the size of an area division unit 120 is 100×480.

When the location of the area division unit 120 determined by the area division unit location determination module 220 is 300, and the location where a touch signal is generated according to the user's choice (i.e., the location of the user's finger on the area division unit 120) is (70, 230), the touch location calculation unit 230 determines (370, 230) as a touch location chose by the user (i.e., the location of the user's finger on the display screen 110, particularly, a third display area) by using the location of the area division unit 120 determined by the area division unit location determination module 220, i.e., 300, and the location where the touch signal is generated, i.e., (70, 230).

The control module 270 searches for an icon corresponding to the touch location determined by the touch location calculation module 230, and executes a function of the identified icon.

The mode setting module 240 sets the display apparatus 100 to a mode set by the user. The display apparatus 100 can be set to a lock mode or a movement mode. The display apparatus 100 can be set to the lock mode or the movement mode by using a lock button (not shown) displayed in a third display area 113.

In detail, when the user deselects the lock button, the display apparatus 100 is set to the movement mode. Then, the user can move the area division unit 120 in a predetermined direction, for example, vertically or horizontally. In the movement mode, the touch pad 121 attached on the top surface of the area division unit 120 does not operate.

When the user selects the lock button, the display apparatus 100 is set to the lock mode. Then, the area division unit 120 cannot be moved in any direction, and only a touch pad function of the area division unit 120 is enabled.

The storage module 250 stores a plurality of commands respectively corresponding to a plurality of menu icons/operation control icons displayed in the third display area 113.

Also, the storage module 250 stores a value indicating a current location of the area division unit 120 determined by the area division unit location determination module 220. The value stored in the storage module 250 is used to calculate a touch location.

The first display module 261 displays content such as still/moving images on a main screen of the display apparatus 100.

For example, if the user chooses a photo view icon, one or more photo files included in the photo view icon are displayed in the first display area 111 by the first display module 261.

The second display module 262 displays a predetermined image on an auxiliary screen of the display apparatus 100. The predetermined image displayed by the second display module 262 may or may not be associated with the content displayed by the first display module 261.

If the user chooses a movie play icon and chooses a predetermined movie file (e.g., the movie “The Matrix”), the chosen movie file may be displayed in the first display area 111 by the first display module 261, and images of other movie files (i.e., the movies “I am Sam,” “Harry Potter,” and “The Lord of the Rings”) included in the movie play icon may be displayed in the second display area 112 as thumbnail images by the second display module 262.

If the user wishes to perform a multi-tasking function using the display apparatus 100, e.g., if the user wishes to play back an MP3 music file while watching photo images stored in the display apparatus 100, the photo images may be displayed in the first display area 111 by the first display module 261, and a list of MP3 music files may be displayed in the second display area 112 by the second display module 262.

The third display module 263 displays a plurality of menu icons/operation control icons, for example, an MP3 play icon, a pause icon, a fast forward icon, and a rewind icon. The menu icons/operation control icons displayed by the third display module 263 can be seen through the area division unit 120 and can thus be displayed to the user.

The control module 270 divides the display screen 110 into the first and second display areas 111 and 112 according to the location of the area division unit 120 determined by the area division unit location determination module 220.

Also, the control module 270 controls the operations of the first signal input module 211, the second signal input module 212, the area division unit location determination module 220, the touch location calculation module 230, the mode setting module 240, the storage module 250, the first display module 261, the second display module 262, and the third display module 263.

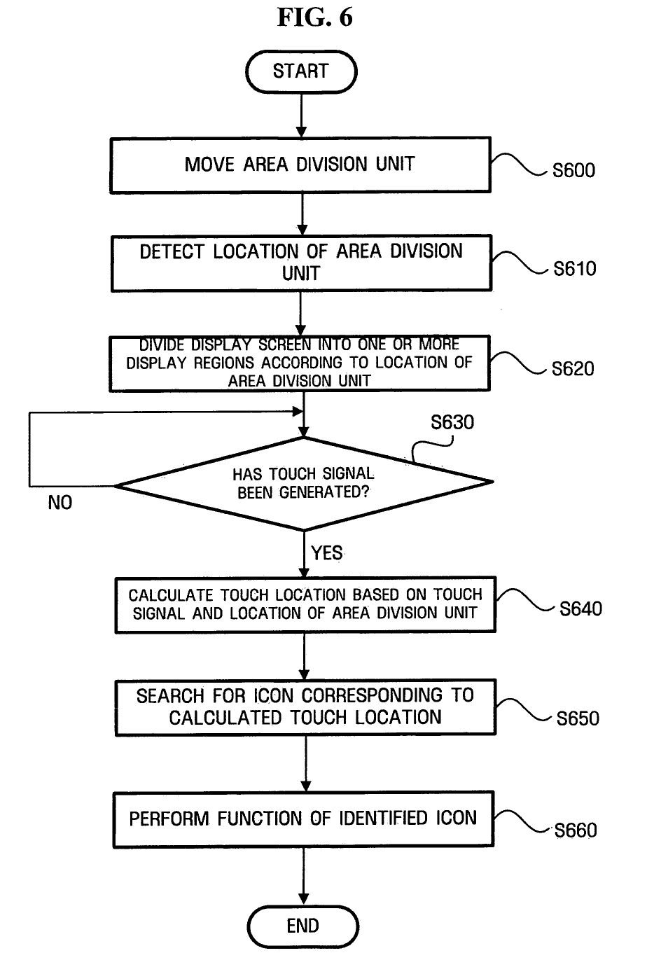

FIG. 6 is a flowchart illustrating a method of providing an area division unit having a touch pad function according to an exemplary embodiment of the present invention. Referring to FIG. 6, in operation S600, a user moves an area division unit 120 included in a display apparatus 100. Before moving the area division unit 120, the user may examine a lock button seen through the area division unit 120 to determine whether the lock button is selected. If the lock button is selected, the user deselects the lock button so that the display apparatus 100 can be set to a movement mode by a mode setting module 240 of the display apparatus 100.

Thereafter, in operation S610, a first signal input module 211 receives a voltage value varied due to the movement of the area division unit 120, and determines a current location of the area division unit 120 based on the received voltage value. A value indicating the current location of the area division unit 120 is stored in the storage module 250.

Thereafter, the control module 270 divides a display screen 110 into a first display area 111 and a second display area 112 according to the value indicating the current location of the area division unit 120. The control module 270 provides a third display area 113 that corresponds to the area division unit 120 according to the value indicating the current location of the area division unit 120.

Thereafter, in operation S630, it is determined whether the user has chosen to operate a touch pad 121. In operation S640, the second signal input module 212 receives a touch signal generated according to the user's choice, and the touch location calculation module 230 calculates a touch location chosen by the user based on the received touch signal and the current location of the area division unit 120. The calculation of the touch location has already been described with reference to FIG. 5, and thus a detailed description thereof will be skipped. Before touching the touch pad 121, the user must select the lock button seen through the area division unit 120 in order to set the display apparatus 100 to a lock mode. When the lock button is selected, the mode setting module 240 sets the display apparatus 100 to the lock mode.

Thereafter, in operation S660, the control module 270 searches for an icon corresponding to the touch location determined by the touch location calculation module 230, and executes a function of the identified icon. When the function of the identified icon is executed by the control module 270, activated content (e.g., a movie file) is displayed in the first display area 111 by the first display module 261.

If it is determined in operation S630 that the user has not chosen the touch pad 121, the second signal input module 212 stands by to receive a touch signal.

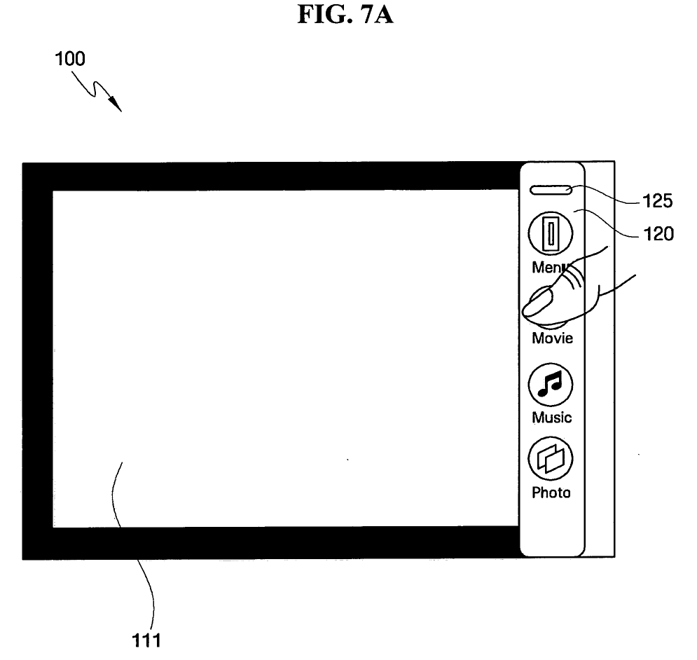

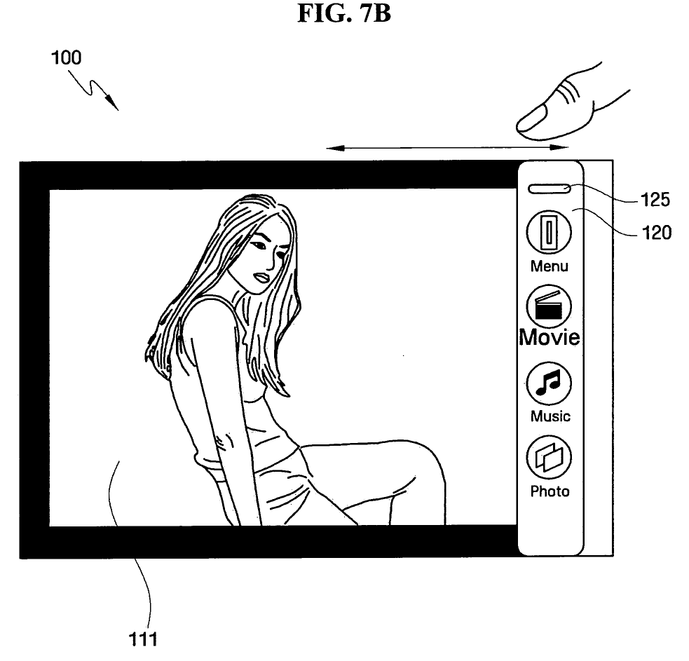

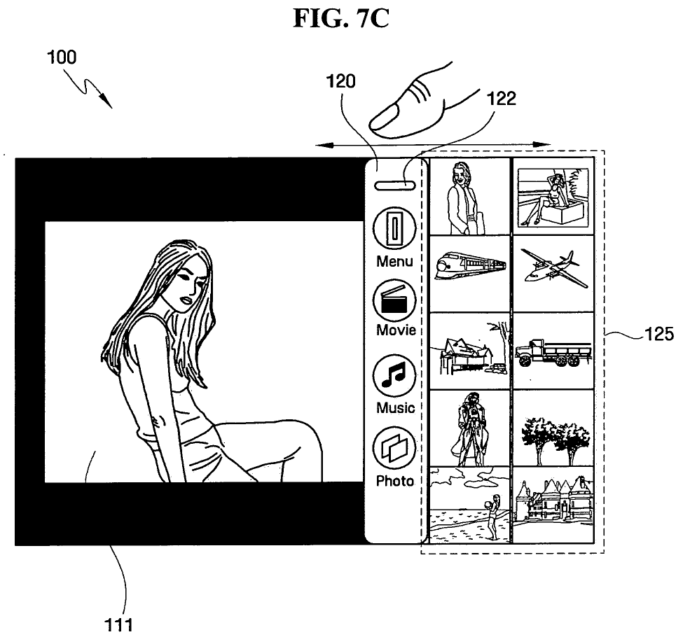

FIGS. 7A through 7C are diagrams for explaining the moving of an area division unit 120 according to an exemplary embodiment of the present invention.

Referring to FIG. 7A, a display screen 110 of a display apparatus 100 only provides a first display area 111 due to the location of the area division unit 120.

If a user chooses a movie icon that is displayed in a third display area and is seen through the area division unit 120 and then chooses a predetermined movie file, the predetermined movie file is played back in the first display area 111, as illustrated in FIG. 7B.

Thereafter, the user sets the display apparatus 100 to a movement mode by using a lock button 125, and then moves the area division unit 120 in a predetermined direction (e.g., to the left) so that the area division unit 120 is positioned as illustrated in FIG. 7C. Then, the display screen 110 is divided into a first display area 111 and a second display area 112 by the area division unit 120. The size of content displayed in each of the first and second display areas 111 and 112 is automatically varied according to the size of the corresponding display area.

A movie file chosen by the user is played back in the first display area 111, and images of other movie files are displayed in the second display area 112 as thumbnail images.

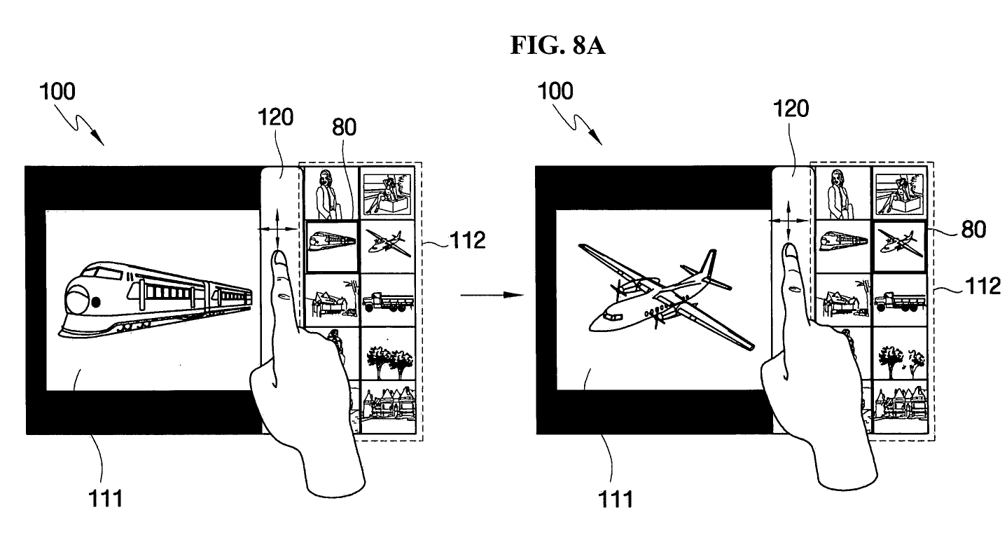

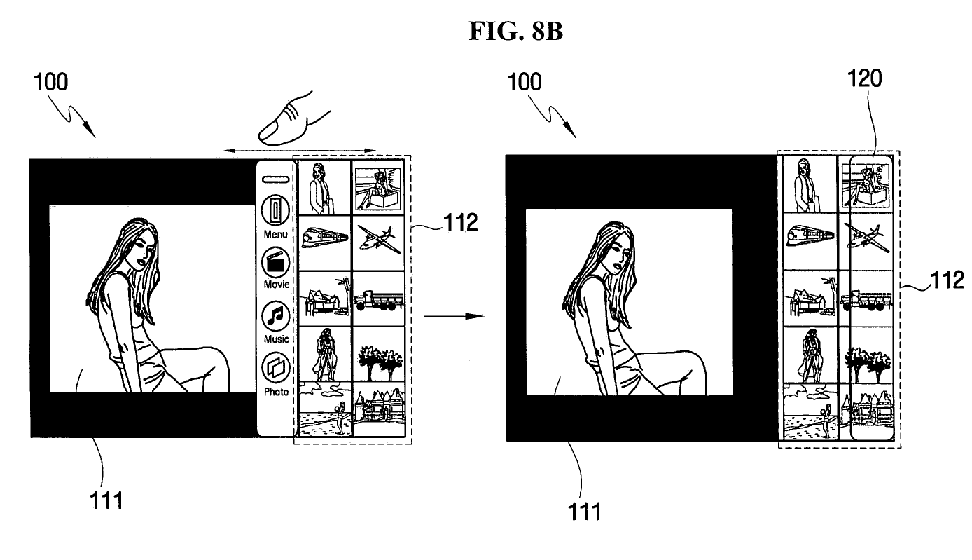

FIGS. 8A and 8B are diagrams for explaining the choosing of an image of interest displayed in a second display area 112 by using an area division unit 120 according to an exemplary embodiment of the present invention. Referring to FIG. 8A, in order to choose a thumbnail image of interest displayed in the second display area 112 with the aid of a touch pad 121 attached on the top surface of the area division unit 120, a user sets a display apparatus 100 to a lock mode by selecting a lock button. Thereafter, the user puts his/her finger on a touch pad 121, and moves it toward the thumbnail image of interest. The user may move his/her finger vertically or horizontally.

For example, when a focus 80 is placed on a train image that is one of a plurality of thumbnail images displayed in the second display area 112, the user puts his/her finger on a portion of the touch pad 121 corresponding to a current location of the focus 80.

Thereafter, the user moves his/her finger toward a thumbnail image of interest, e.g., an airplane image. In other words, when the user's finger is placed on the train image, the user can select the airplane image by simply moving his/her finger to the right while contacting the touch pad 121.

Then, the focus 80 is moved to the airplane image. In short, the user can display an image of interest by putting his/her finger on a portion of the touch pad 121 corresponding to the location where the focus 80 is currently placed and then dragging his/her finger across the touch pad 121 to select the image of interest.

FIG. 8B illustrates the moving of the area division unit 120 toward the second display area 112 and the choosing of an image of interest with the aid of the touch pad 121. Referring to FIG. 8B, a user deselects a lock button, and selects a predetermined function button (not shown). Then, even when the area division unit 120 is moved toward the second display area 112, the re-division of the display screen 110 according to a current location of the area division unit 120 does not occur. In this case, in order to re-divide the display screen 110, the user must deselect the predetermined function button, and then move the area division unit 120.

After selecting the predetermined function button, the user sets the display apparatus 100 to a movement mode, and moves the area division unit 120 toward the second display area 112. Even though the area division unit 120 is moved toward the second display area 112, the re-division of the display screen 110 does not occur.

Thereafter, the user places the area division unit 120 on a predetermined thumbnail image, and chooses the predetermined thumbnail image using the touch pad 121. Accordingly, the chosen thumbnail image is displayed in the first display area 111.

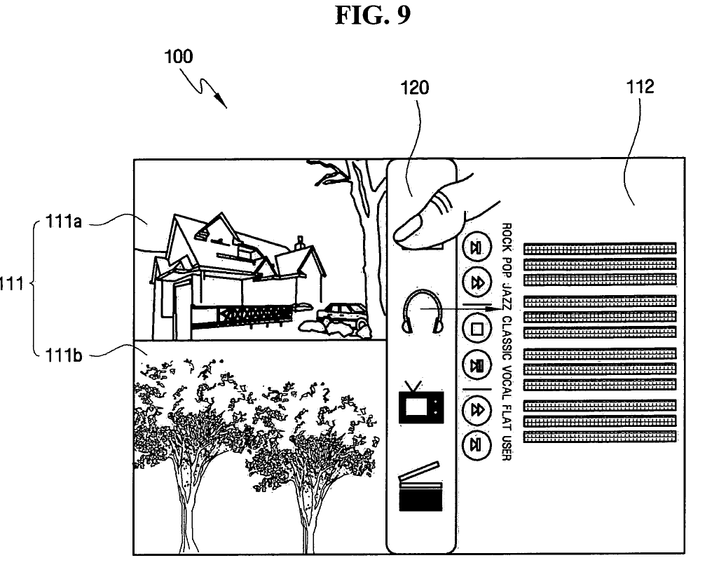

FIG. 9 is a diagram for explaining the performing of a multi-tasking function using first and second display areas 111 and 112 according to an exemplary embodiment of the present invention. Referring to FIG. 9, if a user wishes to play back an MP3 music file while watching photo images, the user moves an area division unit 120 to appropriately divide a display screen 110 into the first and second display areas 111 and 112, and selects a multi-tasking function from a menu item.

Then, one or more photo images are displayed in the first display area 111, and a list of MP3 music files is displayed in the second display area 112. Thereafter, the user can play back one of the MP3 music files included in the MP3 music file list displayed in the second display area 112 by selecting an operation control icon seen through the area division unit 120 (e.g., an MP3 play icon).

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, as used herein, denotes, but is not limited to, a software or hardware component, which performs certain tasks. A module may advantageously be configured to reside on the addressable storage medium/media and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. In addition, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s). Also, components or modules can be embodied in a multimedia card, such as a security multimedia card.

The computer readable code/instructions and computer readable medium/media may be those specially designed and constructed for the purposes of the present invention, or they may be of the kind well-known and available to those skilled in the art of computer hardware and/or computer software.

As described above, the apparatus, method, and medium for providing an area division unit having a touch pad function according to the present invention provide the following advantages.

First, an area division unit included in a display apparatus can be freely moved according to arbitrary user manipulation, and a display screen of the display apparatus can be divided into one or more display areas according to the location of the area division unit. Also, the size of each of the display areas into which the display screen is divided can be freely adjusted according to the user's preferences.

In addition, according to the present invention, a transparent touch pad is attached on the top surface of the area division unit. Thus, a user can intuitively select one of a plurality of icons or images that are displayed on the display screen and are seen through the transparent touch pad. Thus, the user can precisely manipulate the display apparatus.

Moreover, since the transparent touch pad is attached only on the top surface of the area division unit, the display screen can provide clear and vivid images without being adversely affected by the transparent touch pad.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A display apparatus, comprising:
a movable area divider to divide a display screen into two or more display areas, wherein size of at least one display area is determined by location of movable area divider; and
a touch pad which is attached on a top surface of the movable area divider and which is touched by a user to select one of a plurality of icons displayed on one of the display areas.

2. The display apparatus of claim 1, wherein:
the display screen is divided into first and second display areas by the movable area divider;
the movable area divider is located at a third display area of the display screen between the first display area and the second display area, and
the third display area is the one of the display areas displaying the icons.

3. The display apparatus of claim 2, wherein at least one of the icons selects or deselects a predetermined executable operation.

4. The display apparatus of claim 1, wherein size of at least one display area changes when location of the movable area divider is moved, and wherein size of content displayed in at least one of the display areas into which the display screen is divided is adjusted according to change in size of the at least one display area.

5. The display apparatus of claim 1, wherein the touch pad is formed of a transparent material.

6. A display apparatus having a movable area divider, the display apparatus comprising:
a first signal input module which receives a signal that is generated when the movable area divider is moved;
a second signal input module which receives a touch signal that is generated when a user touches a touch pad attached to the movable area divider;
an area divider location determination module which determines the location of the movable area divider relative to a display screen based on the signal received by the first signal input module;
a touch location calculation module which calculates a touch location on the display screen that is selected by the user, based on the touch signal received by the second signal input module and the location of the movable area divider determined by the area divider location determination module; and
a control module which divides the display screen according to the location of the movable area divider determined by the area divider location determination module.

7. The display apparatus of claim 6 further comprising:
a first display module which displays a content item associated with icon in a first display area, wherein the user selected the icon and content item;
a second display module which displays, in a second display area, images of other content items that are associated with the selected icon but are not selected by the user; and
a third display module which displays the icon in a third display area.

8. The display apparatus of claim 6, wherein the touch pad is formed of a transparent material.

9. A method for dividing a display screen into display areas and adjusting size of content displayed in display areas, comprising:
receiving a signal that is generated when a user moves a movable area divider;
determining location of the movable area divider relative to the display screen based on the received signal;
dividing the display screen according to the determined location of the movable area divider into the display areas;
receiving a touch signal that is generated when the user touches a touch pad attached to the movable area divider;
calculating a touch location on the display screen that is selected by the user, based on the received touch signal and the determined location of the movable area divider;
activating an icon corresponding to the calculated touch location; and
adjusting the size of content displayed in at least one of the display areas into which the display screen is divided by the movable area divider according to the size of the at least one display area.

10. At least one computer readable medium storing computer readable instructions that control at least one processor to implement the method of claim 9.

11. The method of claim 9, wherein one the display areas is a portion of the display screen where the movable area divider is located.

12. The method of claim 11, wherein the one display area which is a portion of the display screen where the movable area divider is located contains the icon which is activated to perform a predetermined executable operation.

13. The method of claim 9, wherein the touch pad is formed of a transparent material.

14. The display apparatus of claim 1, wherein the display apparatus displays a content item associated with the selected icon in another display area.

15. The display apparatus of claim 1, wherein one of the plurality of icons is a lock button.

16. The display apparatus of claim 6, wherein one of the plurality of icons is a lock button.

17. A movable area divider attached to a touch pad, wherein:
the movable area divider divides a display screen into at least three display areas which display an icon, content item corresponding to the icon, and information corresponding to the icon in three separate display areas; and
size of content item displayed in one of the at least three separate display areas is adjusted according to location of the movable area divider which defines size of each display area.

18. The movable area divider of claim 17, wherein the movable area divider further comprises a plurality of icons corresponding to a plurality of content items.

19. A movable area divider attached to a touch pad, wherein:
the movable area divider divides a display screen into at least two separate display areas which display an icon and content item corresponding to the icon in two separate display areas; and
size of content item displayed in at least one of the two display areas is adjusted according to location of the movable area divider which defines size of each display area.

20. The movable area divider of claim 19, wherein the movable area divider further comprises a plurality of icons corresponding to a plurality of content items.
